(19) United States
(12) Patent Application Publication
(10) Pub. No.: US 2003/0225650 A1
(43) Pub. Date: Dec. 4, 2003

(54) Web based system and method for asset management

(76) Inventors: Doug Wilson, Lake Forest, CA (US); Rex Tumminia, San Clemente, CA (US); Patrick Moles, Foothill Ranch, CA (US); Kevin J. Bryant, Long Beach, CA (US)

Correspondence Address: MYERS, DAWES & ANDRAS LLP, Suite 1150, 19900 MacArthur Blvd., Irvine, CA, 92612, US

(21) Appl. No.: 10/142,186

(22) Filed: May 9, 2002

(51) Int. Cl. G06F 17/60

(52) U.S. Cl. 705/36

(57) ABSTRACT

A web based method for the configuration of and maintaining assets from web pages or a web based shopping cart during the procurement process. When an individual is purchasing a product or intends to purchase a product the web based method allows the user to perform critical steps in the asset management process. The web based method allows users to implement and maintain the components of assets during the procurement process. The information that the user inputs during the shopping process is captured and placed in a common database that may be SQL based. This captured information can later be modified via web pages. Existing assets can be upgraded using our web-based method during the procurement process.

### BACKGROUND OF THE INVENTION

1. Field of the Invention

The invention relates generally to cleaning asset tracking systems and methods.

2. Description of Prior Art and Related Information

Corporations often lose assets due to the lack of a method for tracking assets at the time of procurement. Frequently, assets are procured and shipped to a staging location prior to reaching their final destination. Corporations will commonly issue physical asset tags after the equipment arrives at its final destination. Conventionally, the physical asset tags are mailed to the same final destination, where the tags are manually affixed to, hopefully, the correct piece of equipment. Common problems associated with this method include loss of tags and errors in affixing tags to the associated piece of equipment.

Other difficulties arise when a company upgrades or adds to an existing asset. The company who purchases upgrades to assets has no way to efficiently track the upgrades. This creates problems in accounting, for example, when it comes tracking to depreciation of the asset and/or upgrade.

### SUMMARY OF THE INVENTION

In accordance with the present invention, structures and associated methods are disclosed which overcome these deficiencies.

A web based method and system is provided for the procurement and tracking of assets from web pages or a web based shopping cart during the procurement process. When an individual is purchasing products or has the intent to purchase products online, a preferred method according to the invention allows the user to perform critical steps for tracking and managing the procured assets.

A preferred web-based method includes several procedures for the establishment of asset management during the procurement process. During the procurement process, an individual would decide that the item to be procured would receive an asset tag identifier. On a procurement web page, shopping cart or web basket, the individual would select the Parent Kit indicator identifying that this item will receive an asset tag identifier. If the item contained one or more components the individual would select the Member Kit indicator identifying that the component or components will be linked to the Parent Kit item. Member Kit items would be added to the Component List under the Asset in the Asset Management System. To add additional components to an existing asset that is recorded in the Asset Management System the individual would select the Upgrade Asset indicator from the procurement web page, shopping cart or web basket and supply the information located on the asset tag or label that identifies the asset in the Asset Management System.

An asset management system comprises a web server and a database. The web server includes a procurement server component configured to provide web pages to an end user for procuring assets and to receive input from the end user for procuring the assets during a procurement stage. The web server also includes an asset management server component configured to receive input from the end user regarding existing assets or assets to be procured, to assign, at the procurement stage, asset tag identifiers to one or more of the assets, and to record information regarding the assets. The database stores information regarding the assets.

The database comprises an asset management component which includes an available asset tag section containing a list of unassigned asset tag identifiers. The asset management component comprises an asset details section containing asset management information relating to each recorded asset, such as specifications information, location information and accounting information. The database comprises a procurement product catalog storing information relating to products which the end user desires to purchase. The procurement product catalog comprises a custom catalog section containing information relating to products determined by the end user, and a system catalog containing information relating to products determined by product suppliers.

The procurement component of the web server is configured to provide web pages to the end user for procuring child items to be associated with a particular asset, and to receive input from the end user for procuring the child items during a procurement stage. The asset management component of the web server is configured to receive input from the end user regarding existing child items or child items to be procured, to associate the child items with the particular asset, and to record information regarding the particular asset and the linked child items.

The particular asset and associated member items collectively form a product configuration. The web server comprises a cloning component for procuring and recording multiple clones of the product configuration. The database may be included in, or separate from, the web server.

A method is provided for procuring and managing assets over a computer network. The method comprises the steps of procuring an asset item during a procurement stage, storing one or more asset tag identifiers useful to a procurer, assigning a particular asset tag identifier to the asset in the procurement stage, and tracking the asset with the particular asset tag identifier.

The tracking step further comprises the step of recording asset management information regarding the asset. The step of recording asset management information regarding the asset comprises the step of recording specification information, location information and accounting information regarding the asset. The method further comprises the step of providing a product catalog through which the procurer procures the asset. The step of providing a product catalog comprises the step of customizing the product catalog to include products from different vendors.

In the event where the asset comprises a parent kit item, the method further comprises the steps of procuring a member kit item to be included with the parent kit item, linking the member kit item to the parent kit item, and tracking the parent kit item and associated member kit item. The parent kit item and the member kit item collectively form an original product configuration. The method further comprises the steps of procuring a clone product configuration of the original product configuration and tracking each product configuration.

Where the asset comprises a parent kit item, the method further comprises the steps of purchasing a member kit item after purchasing the parent kit item, the member kit item being adapted to be added to the parent kit item, linking the member kit item to the parent kit item, and tracking the member kit item.

A method for managing asset components is provided. The method comprises procuring a component to be added to an asset, assigning an asset tag identifier to the asset, identifying the component as a member of the asset, linking the component to the asset in a database, and recording asset management information regarding the component in the database.

A method is provided for procuring and tracking clones of a product configuration. The method comprises selecting a parent asset, selecting a child asset to be associated with the parent asset, linking the child asset to the parent asset to collectively form an original product configuration, procuring clones of the original product configuration, and tracking the original product configuration and each clone.

In summary, a web based method for the configuration of and maintaining assets from web pages or a web based shopping cart during the procurement process. When an individual is purchasing a product or intends to purchase a product the web based method allows the user to perform critical steps in the asset management process. The web based method allows users to implement and maintain the components of assets during the procurement process. The information that the user inputs during the shopping process is captured and placed in a common database that may be SQL based. This captured information can later be modified via web pages. Existing assets can be upgraded using our web-based method during the procurement process.

The invention, now having been briefly summarized, may be better visualized by turning to the following drawings wherein like elements are referenced by like numerals.

### BRIEF DESCRIPTION OF THE DRAWINGS

FIG. 1 is a block diagram illustrating a preferred computer system according to the present invention;

FIG. 2 is a flow diagram for the Asset Management Option Parent Kit;

FIG. 3 is a flow diagram for the Asset Management Option Member Kit;

FIG. 4 is a flow diagram for the Asset Management Option Upgrade Asset;

FIG. 5 shows an example hardware product catalog web page that displays product categories;

FIG. 6 illustrates an example hardware product catalog web page displaying offered products under a particular product category;

FIG. 7 shows an example web page from the Procurement system that features Asset Management Options for a selected product;

FIG. 8 shows the example web page from FIG. 7 wherein the selected product is designated as a Parent Kit Item;

FIG. 9 shows an example web page from the Procurement system wherein a selected product is designated as a member kit item;

FIG. 10 shows an example web page from the Procurement system wherein a selected product is designated as an upgrade and associated with a Parent Kit Item by entering the Asset Tag Identifier of a Parent Kit Item;

FIG. 11 shows an example web page from the Procurement system that features the Purchase Order Details and Asset Details for one Parent Kit Item;

FIG. 12 shows an example web page from the Procurement system that features the Purchase Order Details and Asset Details from a Clone Kit order and lists the Asset Details for multiple items;

FIG. 13 shows an example web page from the Procurement system wherein the details of an entire purchase, including Parent Kit Items and associated Member Kit Items, are displayed;

FIG. 14 shows an example web page from the Procurement system wherein a product configuration comprising a Parent Kit Item and associated Member Kit Item(s) may be cloned;

FIG. 15 shows an example web page from the Asset Management system that features the asset management information for a particular asset; and

FIG. 16 shows an example web page from the Asset Management system that features the Components of an Asset;

FIG. 17 shows an example web page from the Procurement system wherein a product is added to the company catalog section or custom catalog section.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

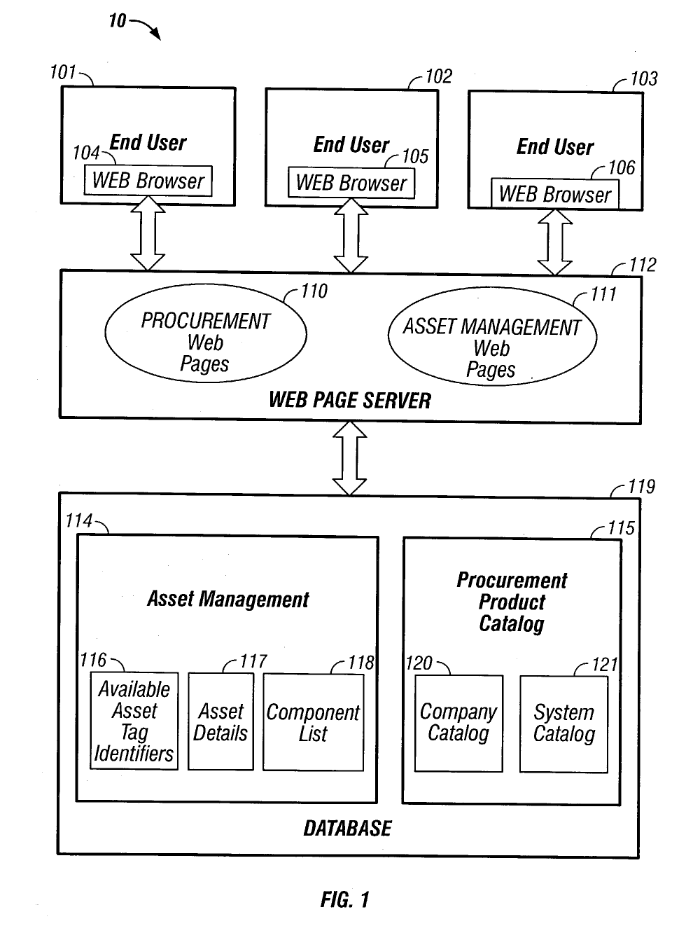

FIG. 1 is a block diagram illustrating a preferred embodiment of a system 10 having networked computers. The system 10 includes a number of end user computers 101-103 with web browsers 104-106, respectively, a web page server 112, and a database 119. The end user computers 101-103 are interconnected to the web page server 112 over a computer network or the Internet. The database 119 for the system 10 may be located on the same computer that houses the web page server 112, or on a separate computer and interconnected to the web page server 112 over a computer network or the Internet.

The web page server 112 includes a procurement server component 110 and an asset management server component 111. The procurement server component 110 provides web pages to the end user computers 101-103 and receives data therefrom for the procurement process. The asset management server component 111 allows for the input and maintenance of asset information during the procurement process.

Information is stored in the database 119 which includes an asset management database component 114 and a procurement product catalog component, or catalog database component 115. The asset management database component 114 stores information related to recorded assets and comprises three sections 116, 117, 118 employed during the procurement process. An Available Asset Tag Identifier section 116 contains a list of unassigned Asset Tag Identifiers. The Asset Details section 117 contains information on recorded “parent” assets, as described further below. The Component List section 118 contains information on recorded “child” components of the parent assets, also described below.

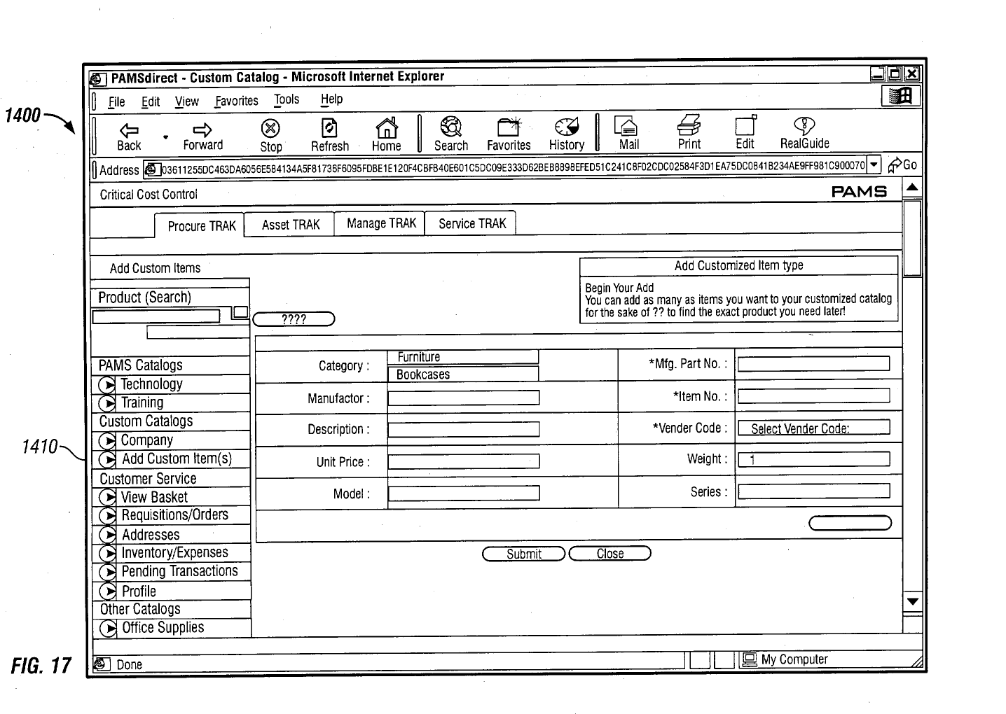

The catalog database component 115 preferably includes two sections. A Company Catalog section, or custom catalog section 120, contains a customized list of products that the end user can input and/or maintain on an as-needed basis. The end user can thus customize the custom catalog section 120 to include product information from a variety of different retailers, as described below in connection with FIG. 17. A system catalog section 121 is maintained and updated by various product suppliers. Therefore, to the extent a product is not included in the system catalog section 121, the user may add the product to the custom catalog section 120. Items from both catalog sections 120, 121 are available to the end user for procurement.

Though FIG. 1 illustrates a simplified, preferred embodiment of the system 10, it should be expressly understood that a very large variety of systems and network topologies as well as a much higher number of end user computers may be employed according to the invention. Though the web page server 112, end user computers 101-103 and database 119 need not reside on the same computer, they could reside together on one or more computers. If multiple computers are used in the system 10, they could be located on an intranet computer network or the Internet.

In the illustrated embodiments, the products being procured and tracked comprise computer products, including both hardware and software. It is to be expressly understood, however, that the systems and methods according to the invention may be applicable to any type of asset for which asset management may be necessary. As an example and not by way of limitation, a user may employ the methods and systems according to the invention to procure and manage office furniture. As used throughout this specification, a parent item, or a “Parent Kit Item,” is an item intended to be tracked independently from other parent items. A child item, or a “Member Kit Item” or “Upgrade,” is an item intended to be included with or linked to a parent item, and intended to be tracked in association with the parent item.

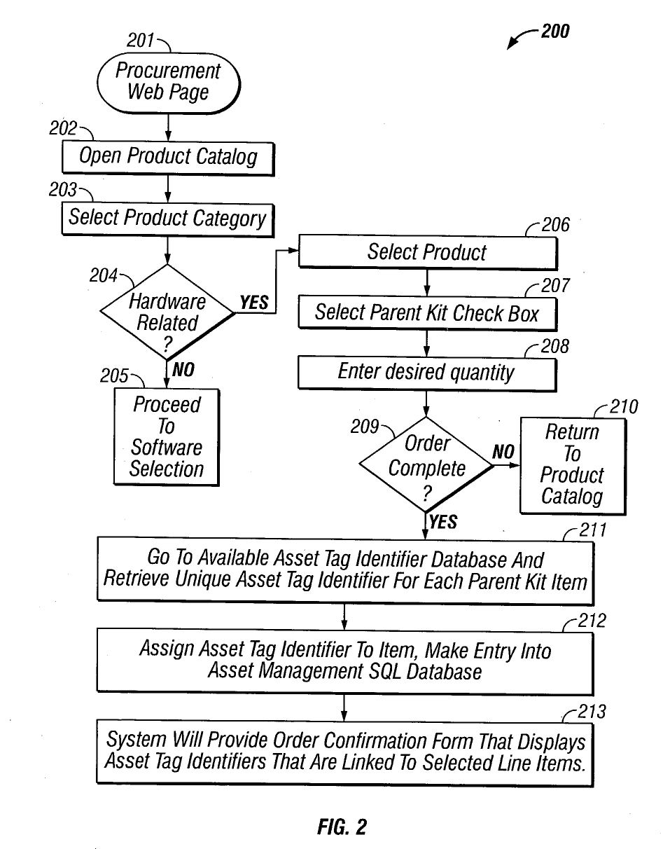

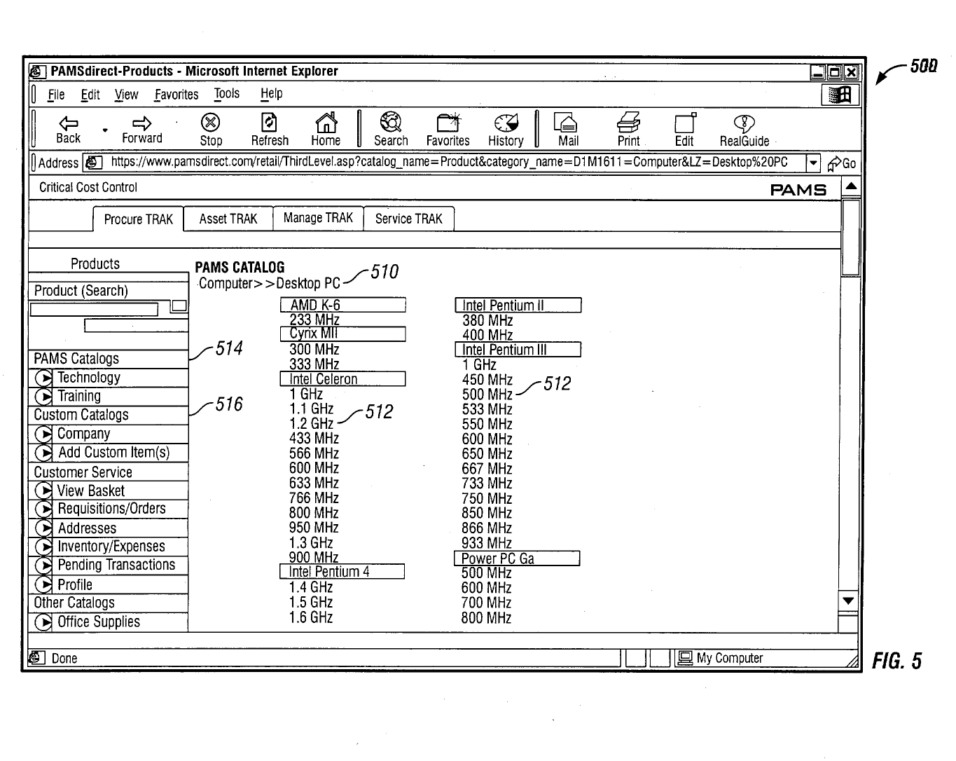

FIGS. 2-4 illustrate flow diagrams for various preferred processes according to the invention while FIGS. 5-17 illustrate example web pages which a user would encounter. For purposes of clarity, several of the example web pages will be described in conjunction with the flow processes illustrated in FIGS. 2-4.

FIG. 2 displays a high-level flow diagram for procuring and concurrently tracking a parent item. FIG. 2 thus illustrates a parent item procurement process 200 that utilizes a Parent Kit Asset Management option according to the invention. During this procedure 200, the end user begins by opening a procurement web page in step 201. In step 202, the user opens the product catalog. In FIG. 5, an example catalog web page 500 displays a variety of hardware sub-categories 512 under a particular hardware category, shown here as “Desktop PC.” As described above in connection with FIG. 1, the user may select from the system catalog section 121 or the custom catalog section 120. If a desired product is not found in either, the user may add the information for the desired product to the custom catalog section 120. In step 203, the user selects the appropriate product category.

Though the present processes and systems according to the invention are not limited to computer related products, it will be appreciated that in the computer field, products primarily fall into hardware and software categories. Therefore, step 204 is optionally provided when the products being procured are computer related. In optional step 204, if the product category is not hardware related, the user proceeds to select a software product in step 205. If the product category is hardware related in step 204, the user proceeds to select a hardware product in step 206.

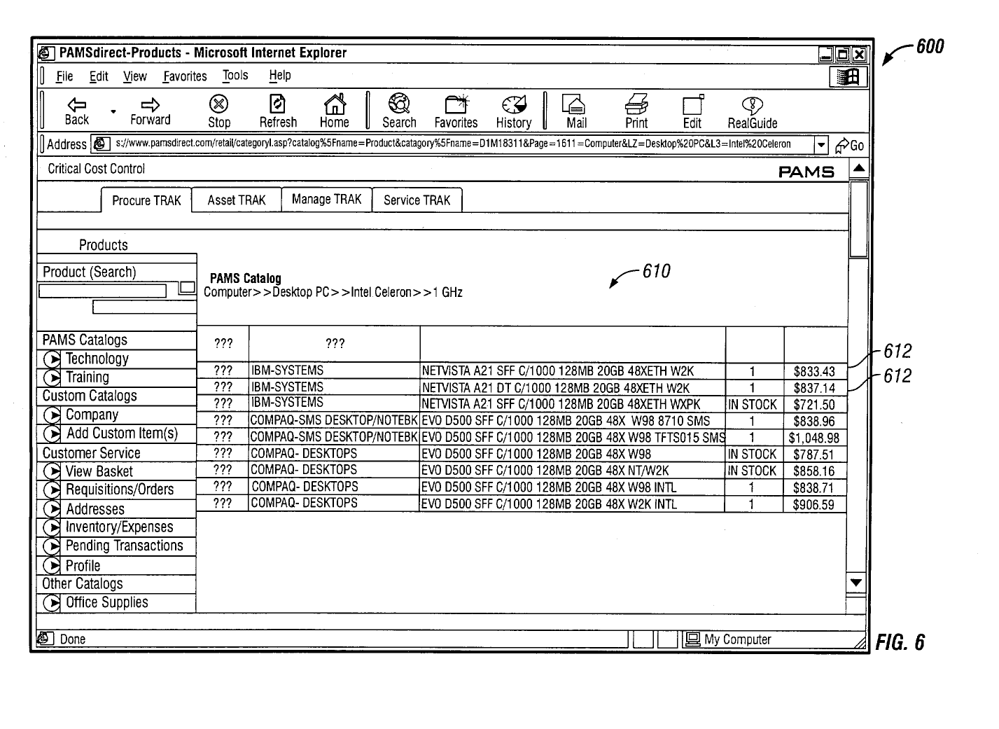

If, for example, a user selects the 1 GHz Intel Celeron sub-category shown in FIG. 5, an example web page 600 in FIG. 6 is provided with a list 610 of applicable products 612. The user may execute step 206 by clicking on a particular product 612. In step 207, the user then marks this “parent item,” or “hard asset,” as a Parent Kit item. During this procurement stage, the system will automatically retrieve an available tag identifier from the Available Asset Tag Identifiers Section 116 of the asset management database component 114 as shown in FIG. 1, and assign the asset tag identifier to the Parent Kit item. In step 208, the user would enter the desired quantity 208.

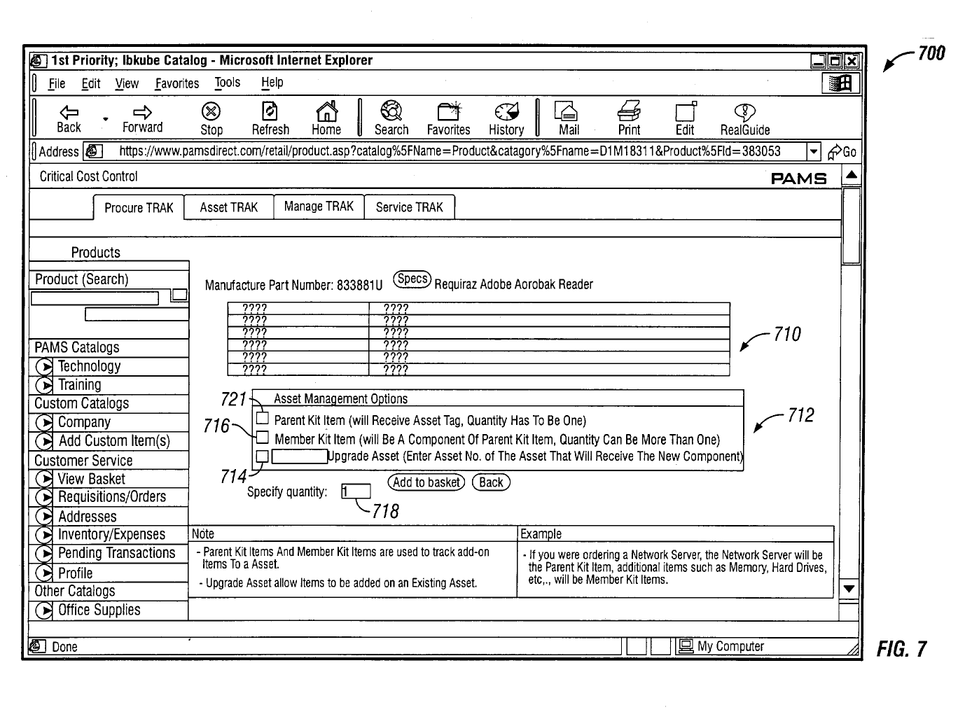

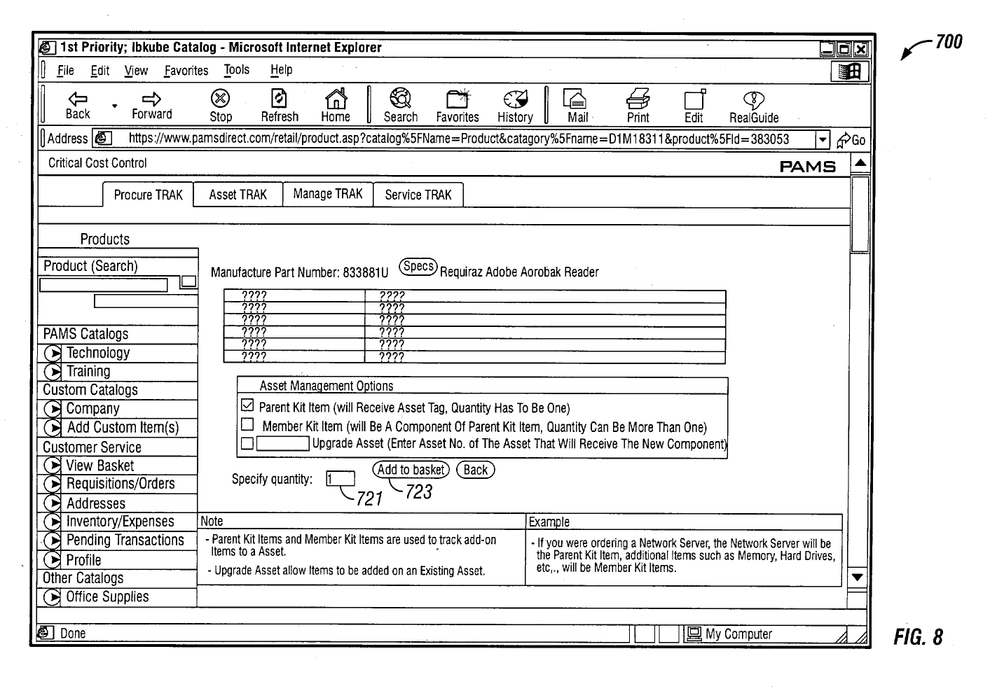

In FIG. 7, an example web page 700 displays a selected parent item, shown here as Mfg. Part No. 633981U. Detailed information 710 is provided on the specifications of the parent item. The web page 700 includes an asset management options window 712 which contains various check boxes 714, 716, 721 for designating for the chosen item. Step 207 of selecting the “Parent Kit’ check box may be performed by clicking on box 721 and step 208 performed by entering “1” in a quantity field 718, as shown in FIG. 8. By clicking an “Add to basket” button 723, an asset tag identifier will be assigned to the parent item. Information pertaining to the parent item, including its specifications and asset tag identifier, is recorded in the database 119, particularly in the asset details section 117 of the asset management database component 114 shown in FIG. 1.

In step 209, if the order is not complete, the user is returned to the product catalog in step 210. If the order is complete in step 209, the end user will submit the order for processing. In step 211, the system will resort to the Available Asset Tag Identifier section 116 of the asset management database component 114 shown in FIG. 1, and retrieve a unique asset tag identifier for each Parent Kit Item. In step 212, the system will automatically assign each Parent Kit Item a unique asset tag identifier and concurrently record a detailed entry in the asset details section 117 of the asset management database component 114, shown in FIG. 1. The available asset tag identifiers may be configured by the user to correspond to the user's system, for example, for filing, labeling, or coding such that the identifiers have meaning and utility to the user. As an example and not by way of limitation, an identifier may comprise a reference number with particular prefixes or sections thereof to indicate to the user what type of asset has been recorded. Thus, if a particular Parent Kit Item falls into a specific category, the system 10 will assign, for example, an available asset tag identifier having the appropriate prefix corresponding to the category.

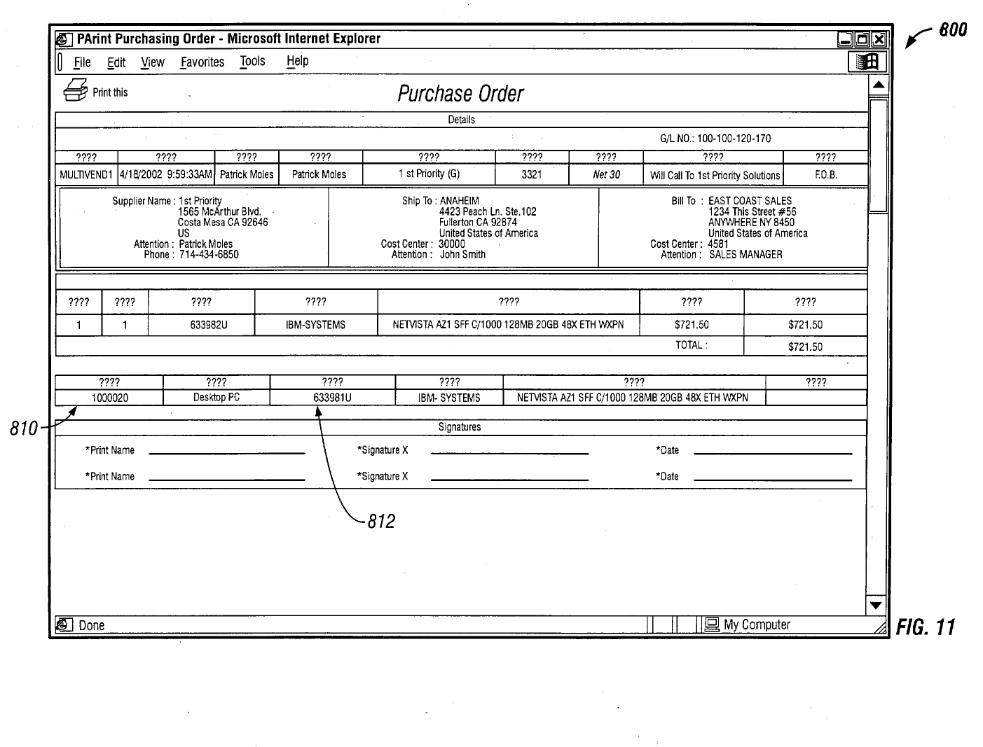

The recorded entry in the asset details section 117 may include information regarding the procured asset's specifications, asset tag identifier, location, order reference number, warranty and shipping details. Upon completion of order processing, the system will provide an order confirmation form in step 213 that displays details on procured items along with their uniquely assigned asset tag identifiers. The order confirmation form may take the form of a purchase order as shown in FIG. 11. In FIG. 11, the asset tag identifier 810 for a procured parent item 812 is displayed. The end user is given the opportunity to print a copy of the Order Confirmation form for their reference.

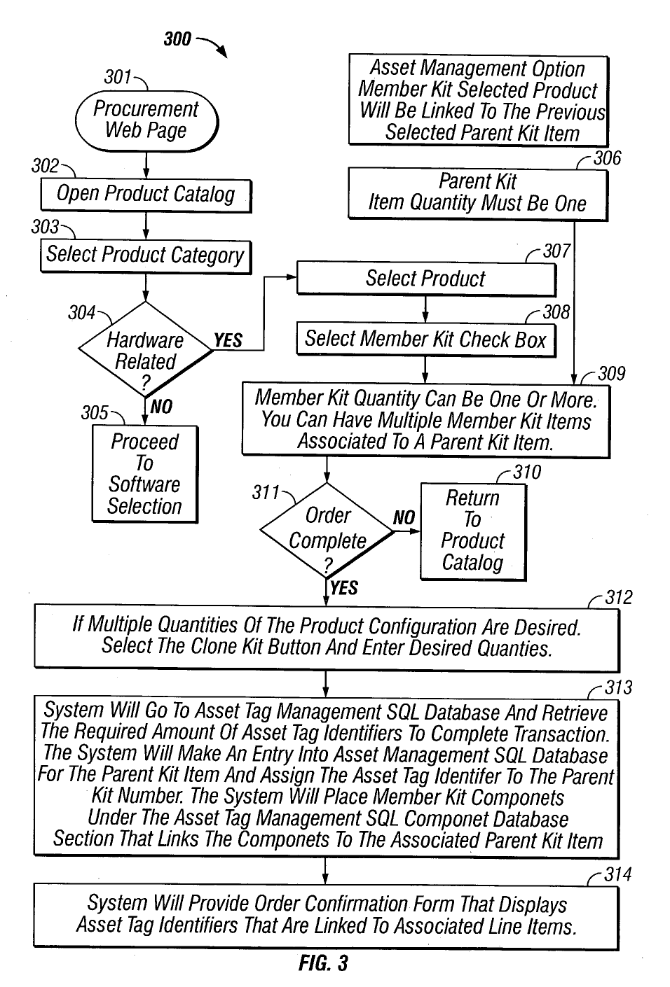

FIG. 3 displays a flow diagram for procuring and concurrently tracking a child item to be associated with the most recently purchased parent item. FIG. 3 thus illustrates a Member Kit Item procurement process 300 that utilizes a Member Kit Asset Management option during the procurement process. During this process 300, the end user can select one or more items from the procurement system that are to be associated with the most recently purchased Parent Kit Item as discussed in connection with FIG. 2. In computer related products, for example, the end user might purchase a CPU which would be designated a Parent Kit Item, and several accessories, such as memory, to be included with the CPU. The memory would be designated by the user as “Member Kit Item” in accordance with the process 300 and, thereby, linked by the system to the associated Parent Kit item that has already been assigned an Asset Tag Identifier as described above. As a further example, the end user might purchase a desk and designate it as a Parent Kit Item and purchase a desk pad to be added to the desk. The desk pad would thus be designated by the user as a Member Kit Item to the desk and linked by the system accordingly.

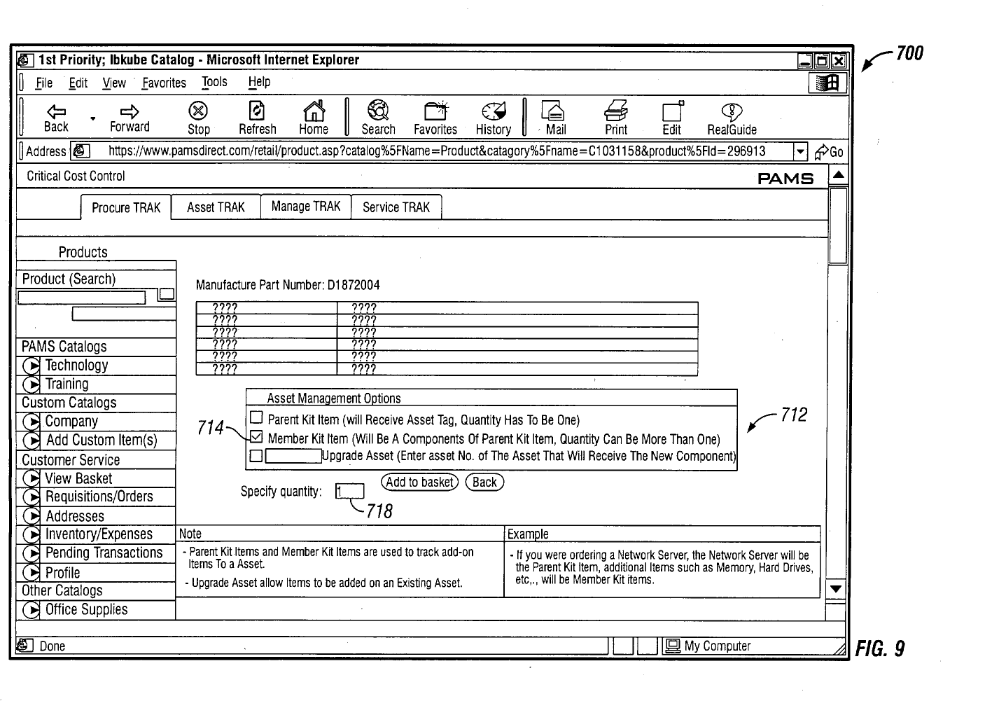

In step 301, the end user would open the procurement web page using the computer web browser. The end user will then open the product catalog in step 302 and select a product category in step 303. In step 304, if the product category is not hardware related, the user will proceed to software selection in step 305. If the product category is hardware related in step 304, the user will proceed to step 307 and select a desired product for procurement. In step 308, the user will designate the chosen product as a Member Kit Item. FIG. 9 illustrates an example web page 700 displaying a sample Member Kit Item. Detailed information 710 for the selected product includes its specifications. In the Asset Management Options window 712, the user would designate the desired product as a Member Kit Item according to step 308 by checking the Member Kit Item box 714. In step 309, the user enters the desired quantity of the product, which may be one or more. In FIG. 9, the user would specify the quantity in the quantity field 718. In step 311, if the order is incomplete, the user is returned to the product catalog in step 310. If the order is complete in step 311, the user proceeds to step 312.

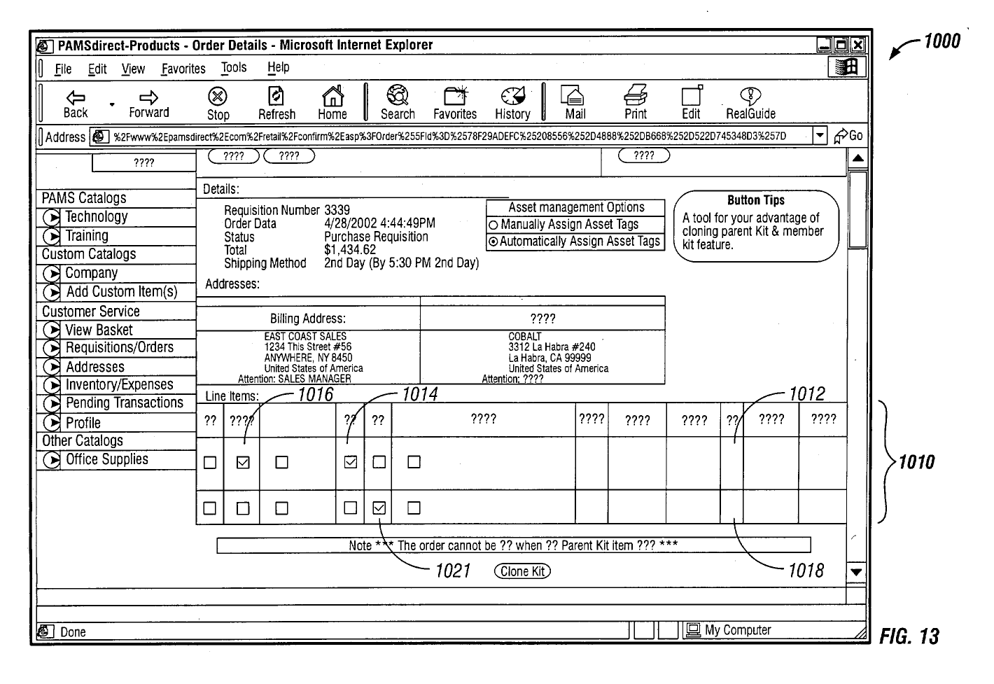

At this point, the user has previously selected a Parent Kit Item in accordance with the parent procurement process 200 shown in FIG. 2. With the completion of the order, a link has been established between the Parent Kit Item and the Member Kit Item(s). The Parent Kit Item and associated Member Kit Item(s) collectively form a product configuration. FIG. 13 illustrates an example web page 1000 displaying a product configuration 1010. In FIG. 13, the product configuration 1010 comprises a Parent Kit Item 1012 as indicated by the checked PK (for “Parent Kit”) box 1014 and Asset Tag box 1016. The product configuration 1010 also comprises a Member Kit Item 1018 as indicated by the checked MK (for “Member Kit”) box 1021.

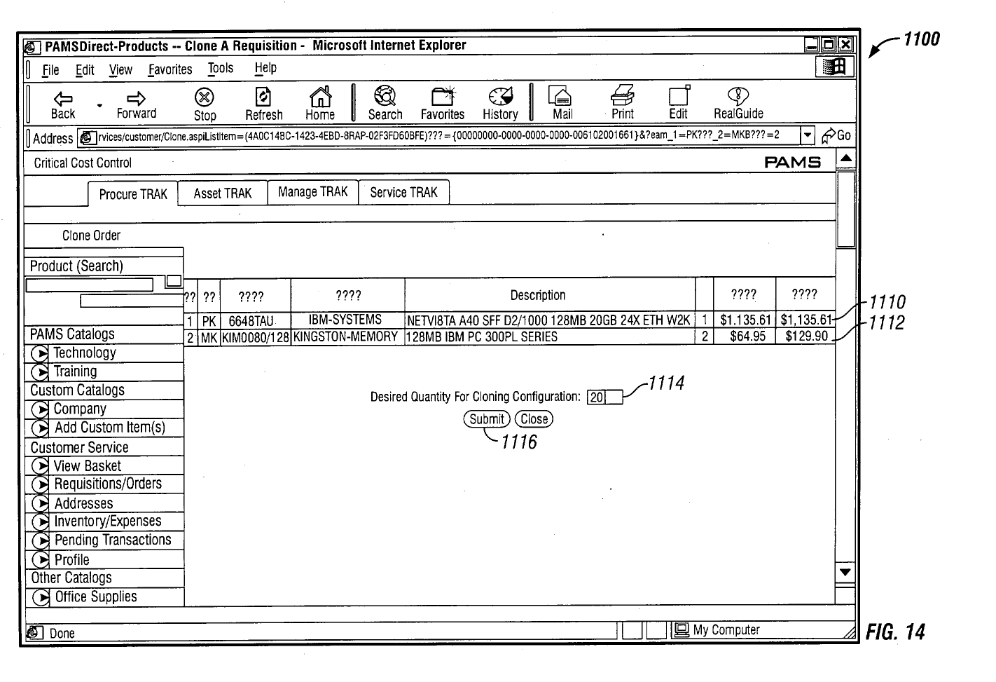

If the end user desires multiple quantities of a particular product configuration, the user may select the Clone Kit option in step 312 and enter the desired quantity. In FIG. 13, the user simply clicks the “Clone Kit” button 1023, which yields an example web page 1100 shown in FIG. 14. The user then enters the desired quantity in the quantity field 1114 and clicks the “Submit” button 116. In the next step 313, the system will go to the Available Asset Tag Identifier section 116 of the asset management database component 114 (shown in FIG. 1) and retrieve a unique Asset Tag Identifier for each new Parent Kit Item of the clone configurations. The system will automatically assign each Parent Kit Item a unique Asset Tag Identifier and make a detailed entry into the Asset Details section 117 of the asset management database component 114. The recorded entries may contain information regarding each Parent Kit Item's specifications, location, asset tag identifier, order reference, and shipping details.

A detailed entry is made in the Component List section 118 of the asset management database component 114 for each corresponding Member Kit Item. The entries for the Member Kit Items are organized such that they are linked to the associated Parent Kit Item. Upon completion of the order processing in step 313, the system will provide an Order Confirmation Form in step 314 that displays details on procured items along with their Asset Tag Identifiers. The end user is given the opportunity to print a copy of the Order Confirmation form for their reference.

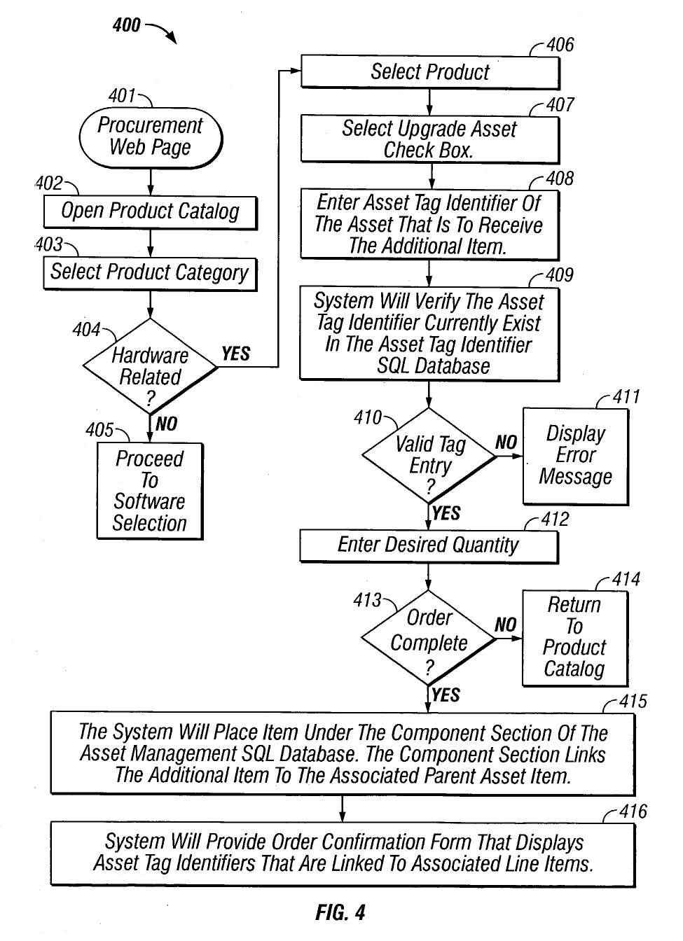

FIG. 4 displays a flow diagram for procuring and concurrently tracking an upgrade for a parent item. FIG. 4 thus illustrates an upgrade procurement process 400 that utilizes an Upgrade Asset option during the procurement process. This process 400 enables the end user to purchase an upgrade for a particular Parent Kit Item and, during the procurement process, to link the upgrade to that Parent Kit Item. The term “upgrade” refers to any child item to be associated with a parent item that was not most recently purchased. For example, the user may desire to link a child item to a particular parent item that was purchased prior to the last purchased parent item. As a further example, the user may already possess an existing parent item and desire to purchase a child item for it.

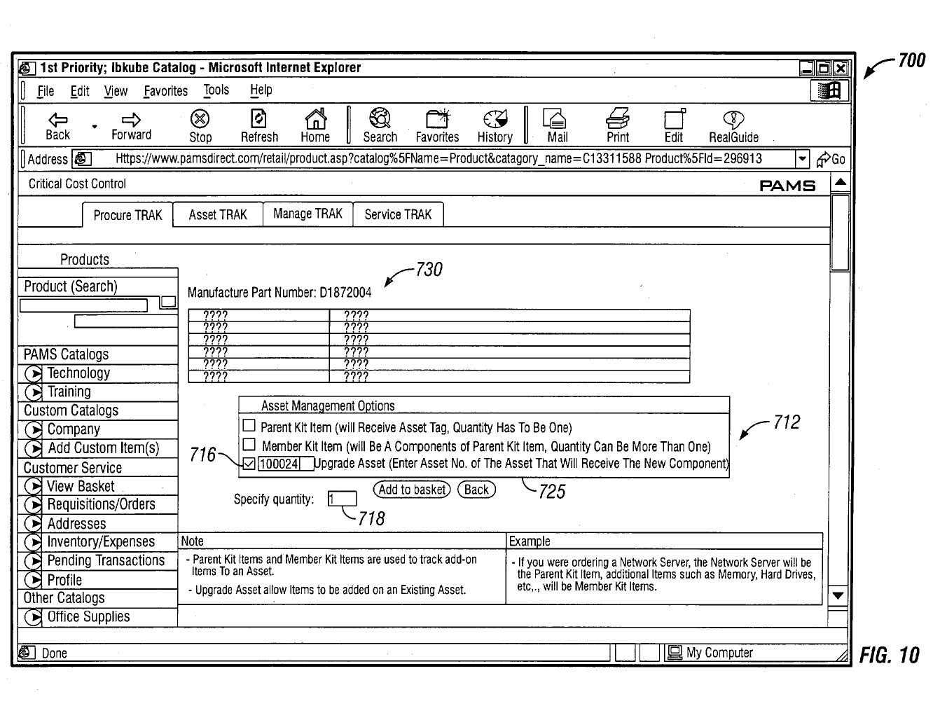

In step 401, the end user opens the procurement web page using their computer web browser. The end user will then open the product catalog in step 402 and select a product category in step 403. In step 404, if the product category is not hardware related, the user proceeds to software selection in step 405. If the product category is hardware related in step 404, the user would select a desired hardware product for procurement in step 406. In step 407, the user will designate the product as an upgrade item and enter the asset tag identifier of the parent asset to which the product shall be linked. FIG. 10 illustrates an example web page 700 wherein a particular product 730 is being designated as an upgrade item by checking the upgrade check box 716 in the Asset Management Options window 712. The asset tag identifier is entered into the asset tag identifier field 725.

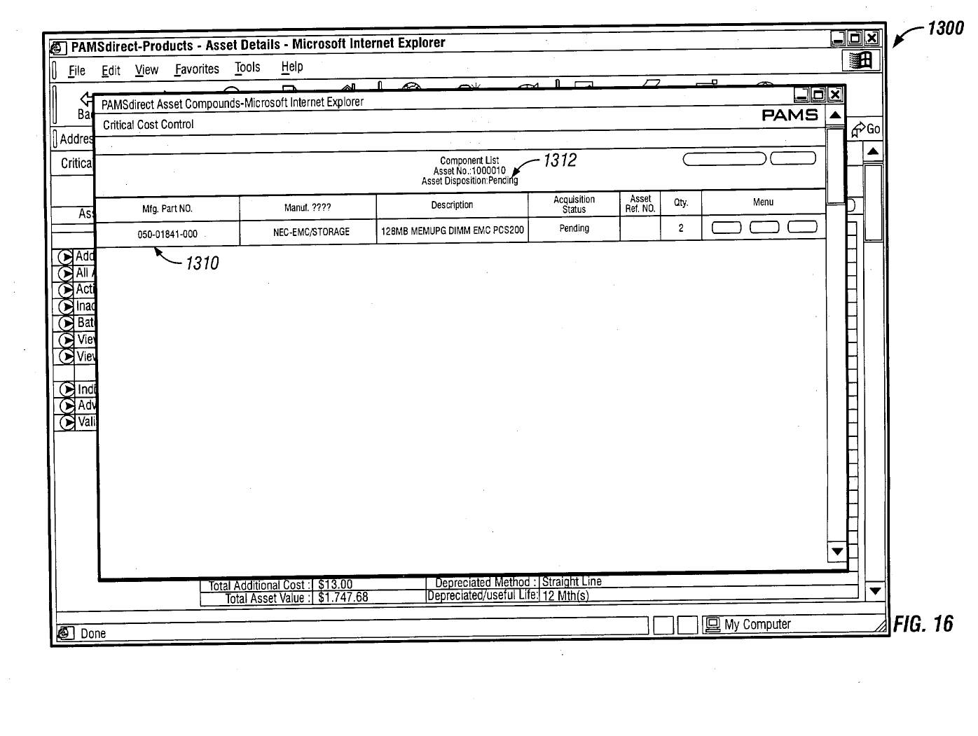

In step 410, the system will verify that the entered Asset Tag Identifier exists in the Asset Details section 117 of the asset management database component 114 as shown in FIG. 1. If it is not, an error message is displayed in step 411. If the Asset Tag Identifier is valid, then the end user will enter the desired quantity of the product in step 412. In step 413, if the end user has the desire to shop for additional items the user may return to the product catalog in step 414. Otherwise, if the order is complete in step 413, the system will proceed to step 415 and link the upgrade item to the associated Parent Kit Item and record the entry in the Component List section 118 of the asset management database component 114, shown in FIG. 1. In step 416, the system will provide an Order Confirmation Form that displays details on the procured items, including the Parent Kit Item to which the upgrade items are linked. FIG. 16 illustrates an example web page 1300 wherein child items 1310 are listed under a particular parent item 1312. The end user is given the opportunity to print a copy of the Order Confirmation form for their reference.

Having described FIGS. 5-17 above in connection with the flow diagrams of FIGS. 2-4, turn now to a further detailed description of the example web pages illustrated in FIGS. 5-17.

FIG. 5 illustrates an example web page 500 from the Procurement Product Catalog. This page 500 displays a category 510 of products, shown here as a Desktop PC. The end user would double click the mouse on a desired sub-category item 512 to receive a list of products that are available for purchase. In the preferred embodiment, two catalogs 514, 516 are provided. The first catalog, or systems catalog 514, is maintained and updated by various product suppliers and is linked to the Systems Catalog section 121 of the database 119 as shown in FIG. 1. The systems catalog 514 thus comprises items supplied by participating vendors. The second catalog, or custom catalog, 516, is maintained and updated by the user and is linked to the Custom Catalog section 120 of the database as shown in FIG. 1. Therefore, should the user desire to procure any item that is not included in the systems catalog 514, the user may add such item to the custom catalog 516 by as described below in connection with FIG. 17.

In FIG. 6, a web page 600 from the Procurement Product Catalog displays a list 610 of products 612 that are available for purchase. For example, by clicking on the 1 GHz subcategory under Intel Celeron in FIG. 5, a corresponding list 610 of products 612 are displayed. The end user would double click the mouse on the MFG. PART NO. to select the product for purchase and receive detailed product information. By selecting a particular product, for example, Mfg. Part No. 633981U, the system proceeds to display an example web page 700 from the Procurement Product Catalog as shown in FIG. 7.

In FIG. 7, line item detail 710 along with an Asset Management Options window 712 for the selected product are displayed. The line item detail 710 includes information regarding the specifications of the selected product. The Asset Management Options window 712 facilitates tracking of the selected product as it is procured. In the window 712, the user will designate the selected product as a Parent Kit Item, a Member Kit Item, or an Upgrade as discussed above in connection with FIGS. 2-4. If selected product is to be included with a Parent Kit Item previously procured, the user will either select Member Kit Item box 714 or the Upgrade Asset box 716 in the window 712. In the quantity box 718, the user may enter one or more. If the item is to be designated as a Parent Kit Item, the user will select the Parent Kit Item box 721 and must designate the quantity as one, as shown in FIG. 8.

In FIG. 8, the initial Asset Management steps discussed in connection with FIG. 2 take place during the procurement process. The Parent Kit Item will be assigned a unique asset tag identifier after the user clicks the “Add to basket button” 723.

FIGS. 9 and 10 illustrate web pages 700 wherein a particular product is designated as a Member Kit Item and as an Upgrade, respectively. If the selected product is to be associated with the most recently procured Parent Kit Item, the Member Kit Item box 714 would be selected. If the selected product is to be associated with an existing asset or a Parent Kit Item that is not the most recently procured Parent Kit Item, the Upgrade Asset box 716 is selected. In order for the system to link the upgrade to a particular Parent Kit Item, the user must enter the Asset Tag Identifier assigned to that particular Parent Kit Item in the asset number field 725. Upon completion of the order for a Member Kit Item or an Upgrade, the system will add the new item to the Asset Management Database Component List of the associated Parent Kit Item.

FIG. 11 illustrates an example web page 800 from the Procurement Catalog and displays the customer Order Confirmation page with line item detail and an Asset Tag Identifier 810 assigned to a Parent Kit Item 812. The end user may print the order confirmation form to maintain a hard copy for their files as well as to generate a purchase order for the supplier. For example, if an ordered product comes from the custom catalog which the user customized and, therefore, is not included with the systems catalog, a purchase order will need to be generated and sent to the vendor.

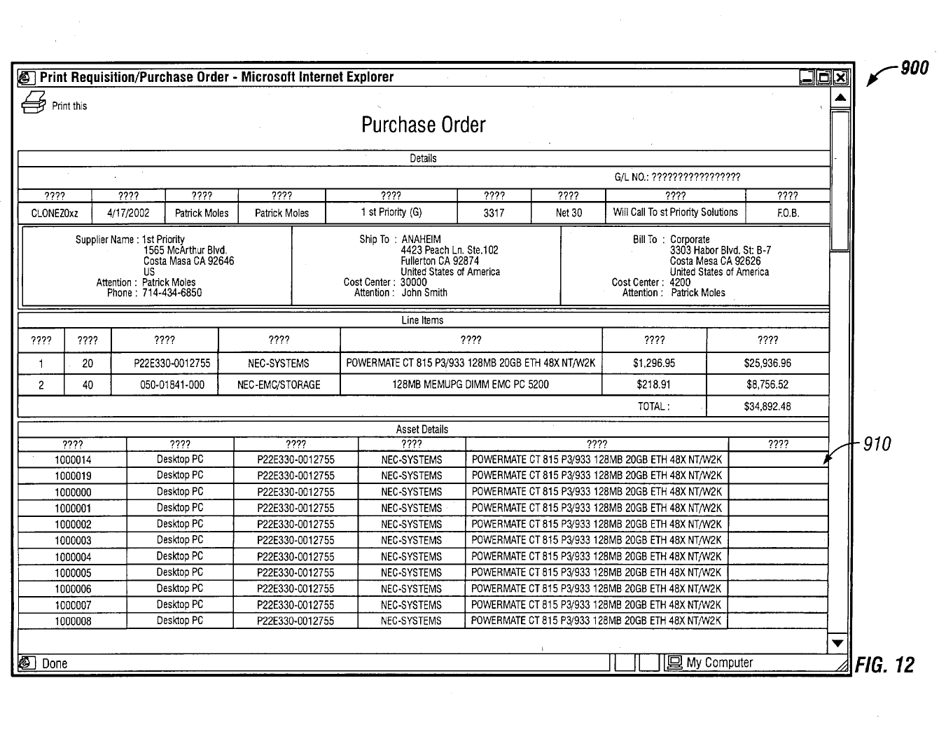

FIG. 12 illustrates an example web page 900 from the Procurement Catalog and displays the Customer Order Confirmation page from an order that was cloned. When an order is cloned, both the Parent Kit Item and any associated member kit items and upgrades, namely the “children items,” are included in each clone. An Asset Details section 910 preferably displays only the Parent Kit Items of the clone along with an Asset Tag Identifier assigned for each Parent Kit Item. The Member Kit items will be entered in the Asset Management Database under the Component List for each Asset. The end user has the ability to print the order confirmation form to maintain a hard copy for their files.

FIG. 13 illustrates an example Order Details web page 1000 from the Procurement Catalog. The purchase details and selected Asset Management Options for a product configuration is illustrated, including the PK (Parent Kit Item) and MK (Member Kit Item) item(s) and any upgrade (none shown here). The end user has the ability to email the Order details to another end user for review or they could print a copy for their records

FIG. 14 illustrates an example web page 1100 from the Procurement Catalog and displays the Clone Order page. An original product configuration comprises a Parent Kit Item and one or more children items. In FIG. 14, for example, the product configuration comprises a desktop PC, namely, the Parent Kit Item 1110, and memory, the child item 1112. Though not shown, a product configuration may also include any upgrades. The end user would input the desired quantity of the product configuration in the cloning field 1114 and click the “Submit” button 1116 for the purpose of cloning the configuration.

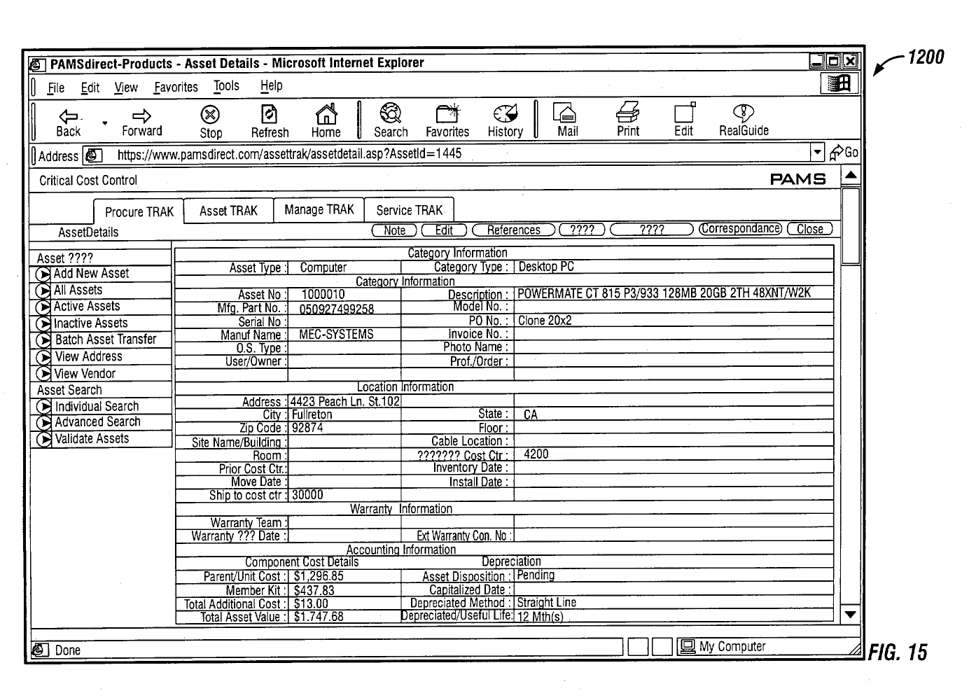

FIG. 15 illustrates an example Asset Details web page 1200 from the Asset Management system. This information is automatically transferred from the Procurement system when the end user commits to a purchase of products by designating them as parent or children items during the procurement process. The end user has the ability to add new items to the Asset Management system.

FIG. 16 illustrates an example Component List web page 1300 from the Asset Management system. The items in this list comprise children items, namely, Member Kit items and upgrades, associated with a particular Parent Kit Item. Items in this list are automatically transferred from the Procurement system when the end user commits to a purchase of products taking advantage of the Member Kit or Upgrade Asset, Asset Management options.

FIG. 17 illustrates an example web page 1400 wherein the user may add a product to the custom catalog section 120 of the catalog database component 115 shown in FIG. 1. The web page 1400 is displayed when the user selects the Add Custom Item(s) selection 1410 in the procurement system. The end user would be required to input detailed information about the product including; Category, Manufacture, Manufacture Part Number (MFG. Part. No.), Description, Item Number (Item No.), Unit Price, Vendor Code, Weight and Series.

In all of the embodiments it will be appreciated that the procured assets may be electronically tagged, especially when the procured items comprise electronic and computer related products. Vendors who participate in the systems and methods according to the invention, may electronically tag the assets being procured by the end user with the asset tag identifiers assigned to the asset by the system. Though the end user may still desire to affix physical labels to the procured assets once received, electronic tagging allows the end user to conveniently recognize and track an asset by simply connecting the asset to a computer network, for example.

With the assets being identified by their asset tag identifiers, end users may easily manage the assets. In addition to tracking the location of such assets, users may account for such assets, including, for example, accounting for depreciation, the number of years remaining on a particular software license, warranty dates, and more. One major benefit of the present invention is that such accounting is made more convenient by identifying the assets at the time of procurement, thereby obviating any double entry into a separate accounting database.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. An asset management system, comprising:
a web server including:
a procurement server component configured to provide web pages to an end user for procuring assets, and to receive input from the end user for procuring the assets during a procurement stage, and
an asset management server component configured to receive input from the end user regarding existing assets or assets to be procured, to assign, at the procurement stage, asset tag identifiers to one or more of the assets, and to record information regarding the assets; and
a database for storing the information regarding the assets.

2. The apparatus of claim 1, wherein the database comprises an asset management component.

3. The apparatus of claim 2, wherein the asset management component comprises an available asset tag section containing a list of unassigned asset tag identifiers.

4. The apparatus of claim 2, wherein the asset management component comprises an asset details section containing asset management information relating to each recorded asset.

5. The apparatus of claim 4, wherein the asset management information comprises specifications information, location information and accounting information.

6. The apparatus of claim 1, wherein the database comprises a procurement product catalog storing information relating to products which the end user desires to purchase.

7. The apparatus of claim 6, wherein the procurement product catalog comprises a custom catalog section containing information relating to products determined by the end user.

8. The apparatus of claim 6, wherein the procurement product catalog comprises a system catalog containing information relating to products determined by product suppliers.

9. The apparatus of claim 1, wherein the procurement component of the web server is configured to provide web pages to the end user for procuring child items to be associated with a particular asset, and to receive input from the end user for procuring the child items during a procurement stage.

10. The apparatus of claim 9, wherein the asset management component of the web server is configured to receive input from the end user regarding existing child items or child items to be procured, to associate the child items with the particular asset, and to record information regarding the particular asset and the linked child items.

11. The apparatus of claim 10, wherein:
the particular asset and associated member items collectively form a product configuration; and
the web server comprises a cloning component for procuring and recording multiple clones of the product configuration.

12. The apparatus of claim 1, wherein the database is included in the web server.

13. A method for procuring and managing assets over a computer network, comprising the steps of:
procuring an asset item during a procurement stage;
storing one or more asset tag identifiers useful to a procurer;
assigning a particular asset tag identifier to the asset in the procurement stage; and
tracking the asset with the particular asset tag identifier.

14. The method of, 13, wherein the tracking step further comprises the step of:
recording asset management information regarding the asset.

15. The method of claim 14, wherein the step of recording asset management information regarding the asset comprises the step of:
recording specification information, location information and accounting information regarding the asset.

16. The method of claim 13, further comprising the step of providing a product catalog through which the procurer procures the asset.

17. The method of claim 16, wherein the step of providing a product catalog comprises the step of customizing the product catalog to include products from different vendors.

18. The method of claim 13, wherein the asset comprises a parent kit item, the method further comprising the steps of:
procuring a member kit item to be included with the parent kit item;
linking the member kit item to the parent kit item; and
tracking the parent kit item and associated member kit item.

19. The method of claim 18, wherein the parent kit item and the member kit item collectively form an original product configuration, the method further comprising the steps of:
procuring a clone product configuration of the original product configuration; and
tracking each product configuration.

20. The method of claim 13, wherein the asset comprises a parent kit item, the method further comprising the steps of:
purchasing a member kit item after purchasing the parent kit item, the member kit item being adapted to be added to the parent kit item;
linking the member kit item to the parent kit item; and
tracking the member kit item.

21. A method for managing asset components, comprising:
procuring a component to be added to an asset;
assigning an asset tag identifier to the asset;
identifying the component as a member of the asset;
linking the component to the asset in a database; and
recording asset management information regarding the component in the database.

22. A method for procuring and tracking clones of a product configuration, comprising:
selecting a parent asset;
selecting a child asset to be associated with the parent asset;
linking the child asset to the parent asset to collectively form an original product configuration;
procuring clones of the original product configuration; and
tracking the original product configuration and each clone.
